(19) United States
(12) Patent Application Publication
(10) Pub. No.: US 2019/0061791 A1
(43) Pub. Date: Feb. 28, 2019

(54) HIGH SPEED THERMAL IMAGING SYSTEM AND METHOD

(71) Applicant: Comet Electronics, LLC, North Kansas City, MO (US)

(72) Inventors: Darrel L. Yaktine, Overland Park, KS (US); Paul E. Myers, Lee's Summit, MO (US)

(21) Appl. No.: 16/116,269

(22) Filed: Aug. 29, 2018

Related U.S. Application Data
(60) Provisional application No. 62/673,452, filed on May 18, 2018.
(60) Provisional application No. 62/551,706, filed on Aug. 29, 2017.

(51) Int. Cl. B61K 9/06; G05D 23/24; G01J 5/00; G01J 5/02; B61K 9/12

(52) U.S. Cl. CPC B61K 9/06; G05D 23/2401; H04N 5/2252; G01J 5/025; B61K 9/12; G01J 5/0022

(57) ABSTRACT

A high speed thermal imaging system includes a thermal imaging camera, the camera including a lens. The housing further includes a front portion and rear portion. The camera and lens are disposed in the housing, which further includes an opening on the front portion. The lens has a field of view through the opening. A rotating shutter disposed in the housing. The rotating shutter may be located between the opening and the optical path of the thermal sensor. The housing may be disposed near a rail track. The lens has a field of view for an object or objects of interest, such as a high speed passing train that includes bearings and brakes of railcar vehicles, (i.e. locomotives, railcars, etc.). The camera may be operable to capture thermal images of the passing rail vehicle wheels including the bearing and brake areas.

### CROSS-REFERENCE TO RELATED APPLICATIONS

This applications claims priority to U.S. Provisional Patent Application No. 62/551,706, filed Aug. 29, 2017, and U.S. Provisional Patent Application No. 62/673,452, filed May 18, 2018, the disclosures of which are incorporated herein by reference in their entireties.

### FIELD OF THE DISCLOSURE

The disclosure relates generally to the field of high speed imaging systems and methods. More specifically, the disclosure relates to the field of capturing thermal images using a camera in conjunction with a rotating shutter.

### BACKGROUND

In extreme situations, the axle bearings of a railcar or locomotive can fail leading to bearing burn off and derailment. To detect such situations, “hot bearing detection systems”—typically known as hotbox monitors or detectors—are installed along railways to monitor the condition of rail car axle bearings during transit.

A hotbox detector has a sensor device, or scanner, that detects the temperature of a body passing within a given detection zone. A typical hotbox detector utilizes infrared sensors to detect heat profiles of the railcar wheel bearings as the railcars roll past the sensor. The same devices are also used to detect sticking brakes, brakes that are not properly engaging the wheel, wheels that are sliding, and other problem areas of the railcar/locomotive or vehicle.

A typical system consists of one or more detection units located trackside defining one or more detection sites, and a processing unit located in a nearby signal hut which collects the values measured by the detectors. Some detectors may communicate with the train/locomotive, others may transmit this data to the traffic control and monitoring section.

If a thermal exception is detected, the locomotive is notified via radio. For example, when a train passes a detection site, axles are logged and counted and a temperature is associated with each bearing. If a bearing temperature exceeds a predetermined value, the system sends a message to the train to stop immediately. The detectors may use other factors for alarms as well, in addition to or without threshold type alarms. For example, the alarm may be a differential type alarm, where the difference between the temperatures from side to side may identify the exception.

Some systems also transmit this data to traffic control and monitoring systems where the thermal information is processed and forwarded to customer's host systems for other purposes such as to develop trends.

There are several issues with current detection system. First, hotbox detectors have a very limited detection area (usually 1 or 2 single pixel thermal detection elements per area). Due to this very limited detection area, they must be specifically aligned to monitor the area of thermal interest. Second, many of such systems are not integrated with Automatic Equipment Identification (“AEI”) technology. AEI includes electronic recognition systems, such as those in use with the North American railroad industry which are currently based on RFID tag reading. Without such AEI technology, in order to locate the hot bearing, the train is stopped and the traincrew must walk the train and count (to the axle) the axle which the system indicated has the hot bearing on and then manually check it. The invention described herein solves these and other problems with past systems.

### SUMMARY

The following presents a simplified summary of the disclosure in order to provide a basic understanding of some aspects of the disclosure. This summary is not an extensive overview of the disclosure. It is not intended to identify critical elements of the disclosure or to delineate the scope of the disclosure. Its sole purpose is to present some concepts of the disclosure in a simplified form as a prelude to the more detailed description that is presented elsewhere.

An example of a high speed thermal imaging system includes a thermal imaging camera, the camera including a lens. The housing further includes a front portion and rear portion. The camera and lens are disposed in the housing. The housing further includes an opening on the front portion. The lens has a field of view through the opening. A rotating shutter disposed in the housing. The rotating shutter may be located between the opening and the optical path of the thermal sensor. The housing may be disposed near a rail track. The lens has a field of view for an object or objects of interest, such as a high speed passing train that includes bearings and brakes of railcar vehicles, (i.e. locomotives, railcars, etc.). The camera may be operable to capture thermal images of the passing rail vehicle wheels including the bearing and brake areas.

In another embodiment, a system for capturing data of a wheel passing at high speed includes a housing; a camera disposed within the housing, the camera comprising a lens; and a rotating shutter disposed within the housing in front of the lens. The housing is placed near the ground such that a field of view of the lens includes the vehicle wheel, and the camera captures a plurality of thermal images of the passing wheel.

In still another embodiment, a system for capturing data of a wheel passing at high speed includes a housing; a camera disposed within the housing, the camera comprising a lens; a rotating shutter disposed within the housing in front of the lens; and an audio sensor. The housing is placed near the ground such that a field of view of the lens includes the vehicle wheel, and the camera captures a plurality of thermal images of the passing wheel. Additionally, the audio sensor is placed near the housing for determining audio data of the passing wheel.

### BRIEF DESCRIPTION OF THE SEVERAL VIEWS OF THE DRAWINGS

Illustrative embodiments of the present disclosure are described in detail below with reference to the attached drawing figures and wherein:

FIG. 1 is a line drawing of an exemplary area scan thermal image of the bearing, wheel, and brakes, the thermal image being shown in FIG. 1A.

FIG. 1A is an exemplary area scan thermal image of the bearing, wheel, and brakes.

FIGS. 1B-1E show other exemplary thermal images of the bearing, wheel, and brakes.

FIG. 2A is an exemplary image taken with a 2 ms exposure and with a shutter.

FIG. 2B is an exemplary image taken with a 16 ms exposure and without a shutter.

FIG. 3 is an example of a thermistor unit.

FIG. 4A is a front view of a housing for the thermal imager or thermal camera.

FIG. 4B is a side view of the housing.

FIG. 5 shows an exemplary diagram of a camera field of view when the camera is mounted near the rail.

FIG. 6 is an exemplary camera and shutter system showing multiple exemplary positions of a rotating shutter.

FIG. 7 is an exemplary configuration of a camera and shutter system within the housing.

FIG. 8 shows multiple image captures of a single wheel as it passes by the camera, showing the image before the train passes by center, at center, and after the train passes by center.

FIG. 9 shows a fusion image according to an embodiment of the invention.

### DETAILED DESCRIPTION

The present disclosure relates to a high speed thermal imaging subsystem used to acquire and analyze two dimensional images or an area scan type image of an object or objects of interest. The objects could include items such as rail vehicle wheels, bearings, brakes and truck assemblies of a moving train. As described herein, the thermal imaging system detects various heat-related failure exception conditions pertaining to these objects which may specifically have an impact on train safety and railcar wheel bearing integrity, among other thermal related conditions. Other thermal interest items, such as sliding wheels, sticking brakes, air hose leakage, and non-affecting brakes may additionally be monitored. The system includes utilizing stop action exposure camera technology to produce a thermal area scan image at high train speeds. A high pixel area scan image (for example, 384×240 pixels or greater) provides for viewing of a larger area, such as of the entire wheel. This is a substantial improvement over prior systems.

Various cameras may be utilized by the system. One type of commercially available camera that is available for high speed thermal imaging is a cooled thermal camera (CTC), which may be MWIR (midwave infrared). CTCs utilize specially designed thermal sensors that must be cooled to temperatures below −200 C to provide accurate and stable thermal readings. They also contain integral electronic shuttering capability as part of the thermal image sensor to allow the stop action shuttering of the thermal image. CTCs are used typically for R&D and science applications in a lab environment or for recording specific high speed thermal events that cannot be viewed by any other means. Although these cameras can support recording the railcar/locomotive wheels and the bearing area, they are expensive and are typically not suited for installation at an unattended trackside railroad environment.

Uncooled thermal cameras (UTCs) based on bolometers are also commercially available for use in other applications. For example, UTCs are used in many security applications to allow viewing in total darkness. UTCs are small, lightweight, and are well suited for unattended environments and applications in which the objects being viewed are moving slow. However, for high speed objects, like trains, these cameras as currently available would produce smear or motion blur. Smear or motion blur is the capture of apparent streaking in a still image or sequence of images. The streaking or smear is due to changes of the object being recorded in a single exposure. The object changes because of the rapid movement being captured in one frame.

The frame rates/integration times/exposure times for UTCs are typically around 8 to 16 milliseconds. When using these cameras to take pictures of moving objects, the integration time relates to lag or speed smear in the image. For example, a train moving at 60 MPH moves about 1 inch in 1 millisecond. If the integration time of the sensor is 16 milliseconds, there would be approximately 16 inches of smear. For a 60″ field of view this relates to about (16 inches/60 inches) of movement or about 27% smear in the image at 60 MPH. The resulting images are therefore unclear to a reader.

The invention described herein solves the speed smear problem. Specifically, in embodiments, the high sped imaging system utilizes a longwave infrared (LWIR) bolometer-based thermal camera. The thermal camera is integrated with a motor driven rotating mechanical shutter assembly as described herein. While LWIR thermal cameras are commercially available, such cameras have not previously been used for high speed thermal imaging as disclosed herein, including for capturing parts of high speed trains such as railcar wheels, bearings, brakes, and truck assemblies.

In an embodiment, shutter openings of a shutter assembly can be configured using a pair of adjustable blades for two openings. However, the shutter assembly may also be configured using a single shutter blade with one opening. The shutter configuration may depend on the image acquisition requirements and the stop action exposure required.

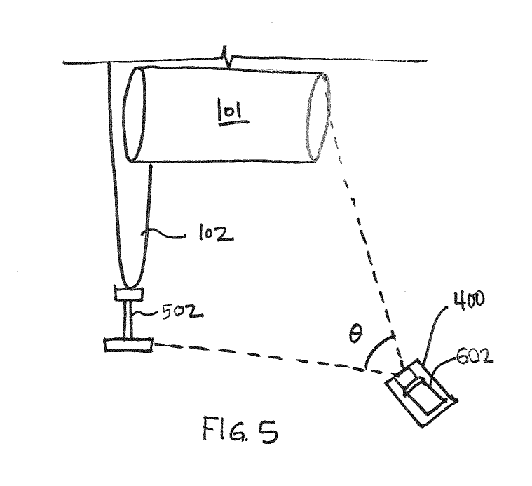

FIG. 6 shows an example of a camera/shutter assembly 600 with optional dual shutters. The camera 602 and a lens 603 are protected by a cover 601. A rotating shutter 604 is disposed between the lens 603 and front of the cover 606. A second rotating shutter 605 is optionally disposed between the lens 603 and the camera 602. The cover 601 will preferably include only one of the rotating shutters (e.g., shutter 604 or shutter 605), but it may include both. A solenoid, also disposed within the housing, controls the rotation of the shutter. It shall be understood by those of skill in the art that other rotational mechanisms may be optionally be utilized in place of a solenoid.

The shutter may spin at approximately 1800 RPM (revolutions per minute). A tach signal is detected when the blades are open and this signal may be used to reset the camera timing to take a picture and to provide an indication of the duration/exposure of the shutter for the picture. For a single shutter opening this signal may occur at (1800/60) or every 1/30 of a second or every 33 milliseconds per frame. Similarly, if a different frame rate is desired a dual opening shutter can be selected or the shutter can be set to spin at different rates. Since the camera frame rate is controlled by the shutter, the frame rate or picture rate is directly related to the speed of the rotating shutter.

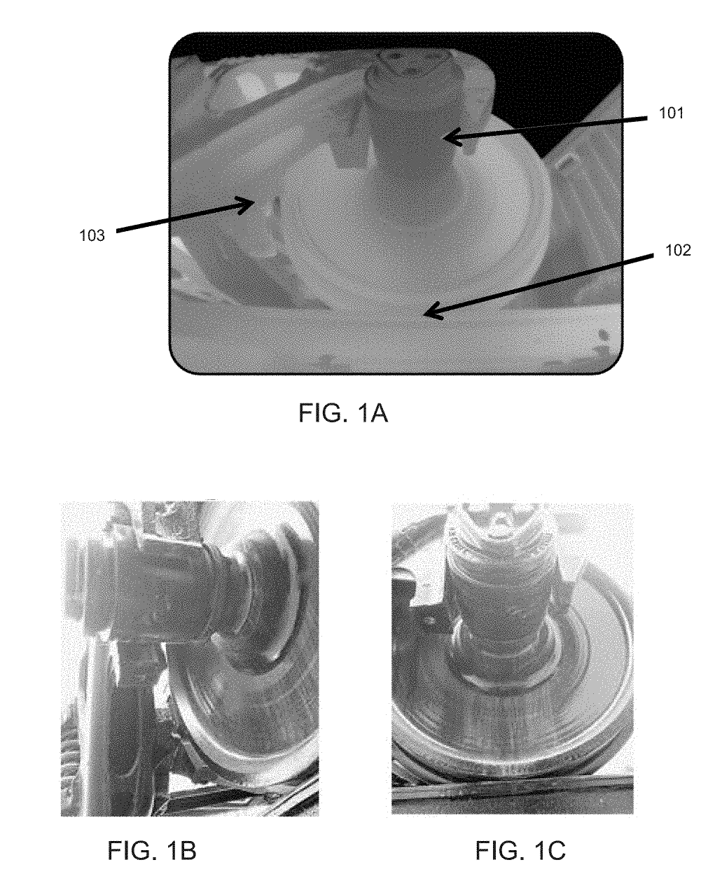

For stop action performance, a shutter exposure of 2 milliseconds (ms) and a frame repetition rate of approximately of 30 milliseconds may be used. This relates to about 2 inches/60 inches of movement or about 3% smear in the image at 60 MPH. FIGS. 2A and 2B demonstrate the effects of implementing a rotating shutter as described herein. In FIGS. 2A and 2B, the camera has a horizontal field of view (FOV) of approximately 60 inches. FIG. 2A represents an image taken by a LWIR thermal camera having a shutter with a shutter exposure of 2 ms of a wheel bearing 101 of a train moving at about 50 MPH. The bearing 101 is easily identifiable. To the contrary, the image in FIG. 2B was taken by a thermal camera without a shutter, with a 16 ms exposure. The contrast between FIGS. 2A and 2B is clear—the bearing in FIG. 2B is nearly unrecognizable due to the smear shown in the image.

In another embodiment, to obtain stop action performance, the shutter is locked to the camera timing. Here, additional electronics between the thermal imager and the shutter tightly controls the speed and phase of the rotating shutter with respect to the imager's internal frame rate.

When the scene exposure limited by the rotating shutter is less than the “thermal time constant” of the thermal imager, the thermal readings are corrected based on the reduced exposure. One potential implementation is to provide controlled thermal reference targets in the field of view of the thermal image during testing. This implementation may also be used during production. The temperatures of these references may be tightly controlled and monitored and used to reference what the thermal camera sees to these known temperatures. This approach may augment thermal accuracy and reduce complex calibration procedures.

The external heat sources for temperature references in the image may be high-wattage power resistors with thermistors attached to them for monitoring. The voltage applied to these resistors may be adjustable in software to maintain any temperature between 40° C. and 300° C. on a resistor by resistor basis.

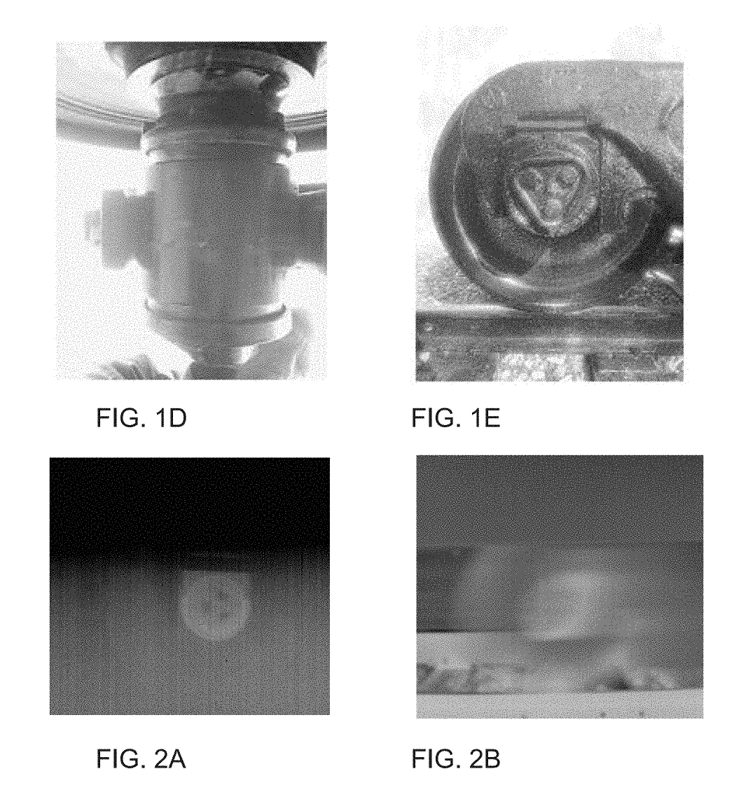

FIG. 3 is an example of a thermistor unit. The thermal system may maintain the resistor temperature using a servo loop using the thermistors for temperature feedback. The resistors 301 may be mounted approximately 4 inches apart on ½ inch standoffs inside a 20-inch-long channel 302, although such a configuration is not required. The unit may be mounted or placed next to the rail. The rail temperature readings may also be monitored to aid in the accuracy of the thermal readings during testing, calibration, or while a train is passing.

The known temperature references may be electronically monitored and recorded. Further, these thermal temperature references may be used to help determine the actual temperatures of the item being imaged (such as the wheel bearing, brakes or other areas of wheel exhibiting excessive heat). An exemplary temperature range of consideration of items within the camera's field of view may be between 0° C. to 650° C. While 0 to 650 is sufficient and one target, a primary thermal interest of temperatures between 80° C. and 200° C. could also be desired.

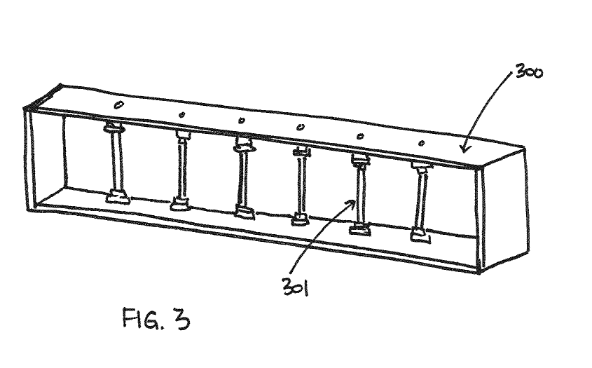

The camera/shutter assembly 600 may be secured in a housing. FIG. 4A shows front view of an exemplary housing 400 for a thermal imager or thermal camera. FIG. 4B is a side view of the housing. The housing includes a front portion 401, a rear portion 402, and respective side portions 403. The front portion has an opening 404 to allow the camera to capture images outside of the housing. The housing may further include a base 405 configured to mount to an object to prevent theft and movement of the camera. The housing may also include a conduit. The conduit may support AC power, DC power, a network such as a Rj45 network, and three or four shielded pair cable.

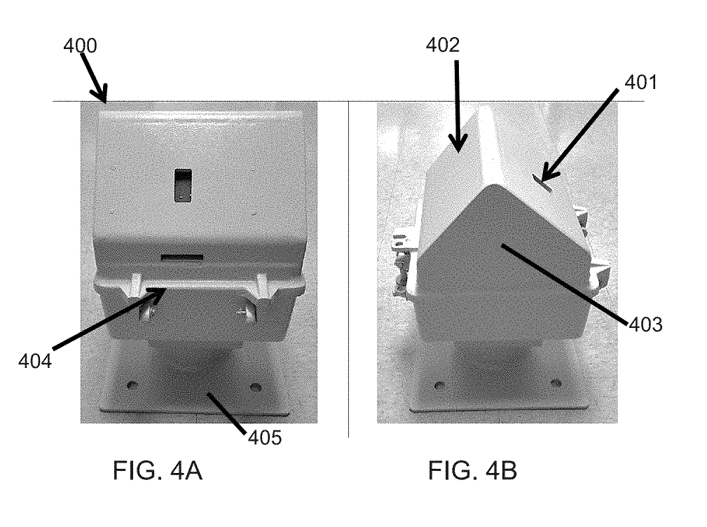

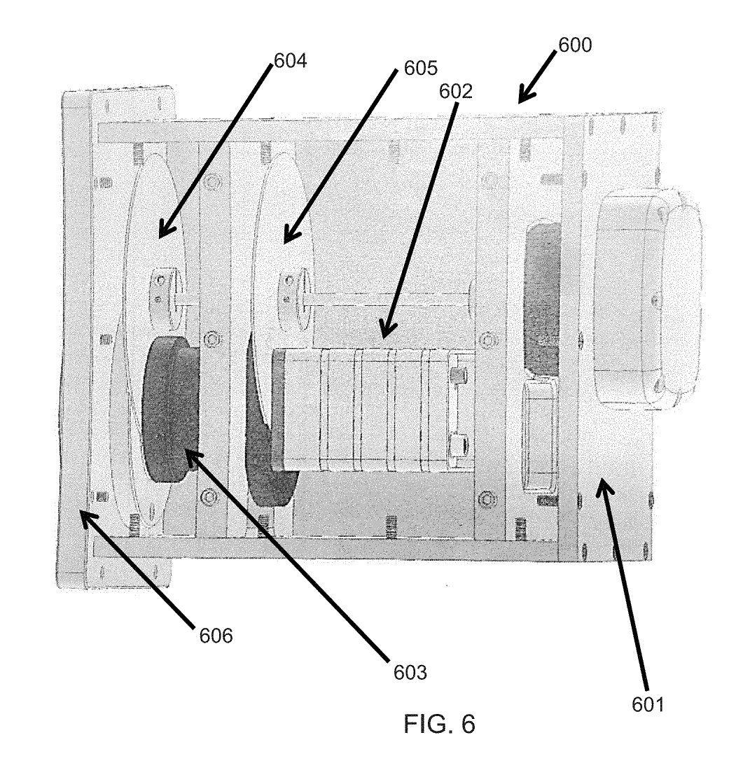

The camera/shutter assembly 600 is mounted inside the housing 400 such that the camera has a field of view outside of the housing 400. FIG. 7 illustrates the camera/shutter assembly mounted in a housing 400. FIG. 5 shows an example of a camera's field of view having an angle θ when mounted in a housing 400. The housing 400 is positioned so that the opening 404, and thus the lens 603 is below the rail 502, for example, about 2 inches below the rail. The housing may also be mounted near the rail 502, but not substantially next to it, for example, about 2-4 feet away from the rail 502.

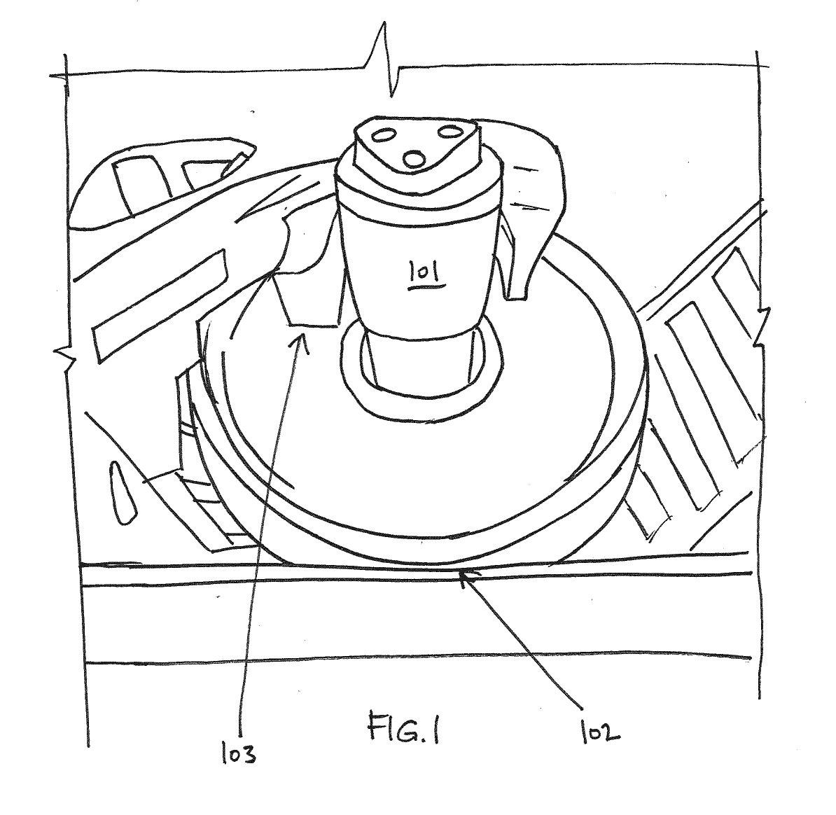

When the housing 400, and therefore the camera/shutter assembly 600 is positioned near the rail (e.g., as shown in FIG. 5) the camera 602 may begin capturing images of passing vehicles. FIG. 1 shows a line drawing of, and FIG. 1A shows an area scan thermal image of, a bearing 101, wheel 102, and brakes 103 on a passing train. FIG. 1A illustrates an example of a captured field of view (FOV) of the imaging device, sensor or camera. The high pixel area scan image shown in FIG. 1A allows the viewing and thermal detection of a larger area (such as of the wheel, bearing and brake) all at once, using one area scan image sensor.

As shown in FIG. 1A, the area scan thermal image provides a clear view of the bearing, wheel and brake area and can simultaneously provide thermographic detail about any of the areas within the train truck area for thermal analysis.

Other FOVs can be used to capture additional or differing aspects of the train. For example, FIGS. 1B-1E show other FOVs captured by the imaging device. FIG. 1B is a slide/forward or trailing view of the bearing 101, wheel 102, and brakes 103. FIG. 1C is a straight/up-angle view. FIG. 1C is a straight up or near straight up view, and FIG. 1E is a straight on view. A system may use one or more imaging devices to capture one view, multiple views or all such views.

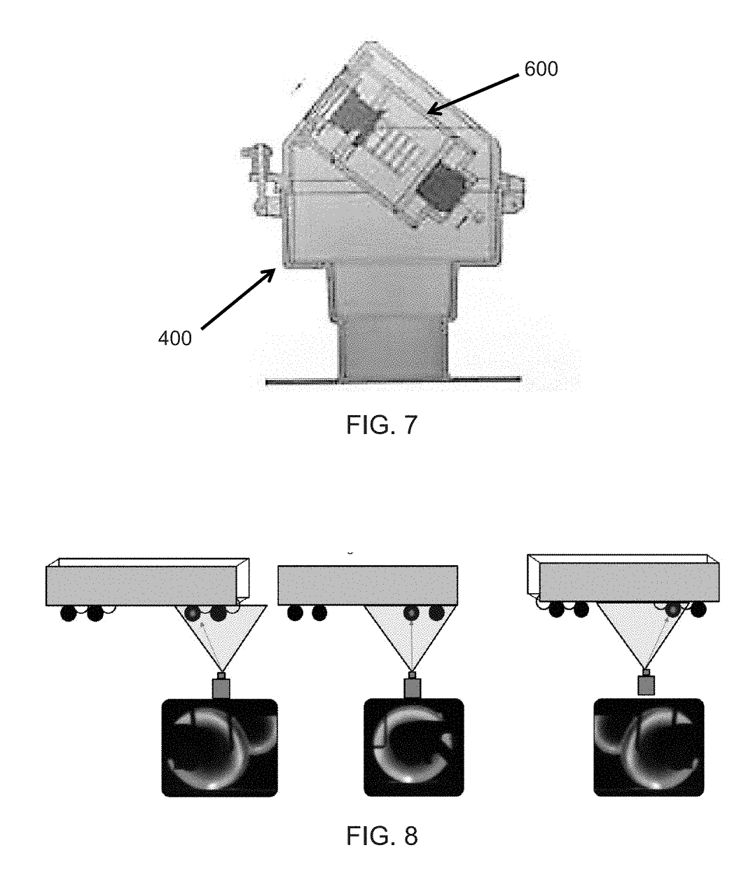

FIG. 8 illustrates an imaging device or devices capturing multiple views of a train wheel. In FIG. 8, the field of view of the camera is widened such that multiple images may be captured as a wheel is passing in front of the camera. The camera may capture a first image before the wheel passes by the center of the camera's field of view. Thus, the first image may include a front perspective view of the wheel. A second image may be captured when the wheel is at the center of the camera's field of view. A third image may then be captured when the wheel has passed by the center of the camera's field of view. The third image may therefore include a rear perspective view of the wheel. Additional, or fewer images, may be captured as is desirable.

By capturing multiple images of the wheel rather than one single image, it may be possible to obtain additional information which may be helpful in detecting and/or confirming the presence of an issue with the wheel. Possible issues may include but are not limited to a sliding wheel or a sticking.

The thermal imaging device may be installed in many locations appropriate for the FOV desired or train area desired to be captured. For example, the imaging device may be installed at similar locations as prior hot bearing/wheel detection sensors. The imaging device may be installed at a railroad tie mount, in-between rails, in ground by the rail, or on the AEI antennas mast. Further, in some cases, like detecting a sliding wheel, it may be mounted the AEI masts about 8 feet away on either side of the rail. One or more imaging devices may be place at one or more of these locations depending on the needs of the system.

The thermal imaging system may also be integrated with Automatic Equipment Identification (AEI) technology. AEI technology often uses radio frequency identification (“RFID”) to identify rail vehicles in a passing train using trackside readers, although other AEI systems may be utilized whether now known or later developed. AEI reader systems will identify the standing order rail vehicles and their respective axles and provide this information to the railroad host computer system or to the track side thermal imaging system to associate a thermal event directly with a rail vehicle and/or a particular axle. This may allow an operator to more quickly identify the area of concern and take corrective action if necessary.

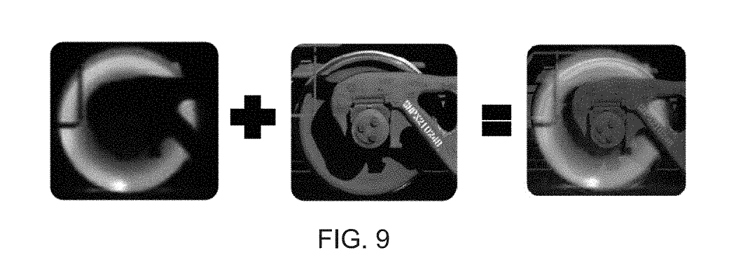

In embodiments, the thermal image captured by the imaging device may be combined with a color image of a wheel to obtain a fusion image, such as that shown in FIG. 9. By combining the captured image with the color image, potential issues with the wheel may be more easily identified. The combination of the thermal image with the color image provides information which would not be available with only the thermal image or the color image. By superimposing the thermal image onto the color image, a user may be able to quickly identify the problem area on the wheel because the thermal profile will correspond to an area on the color image which is readily identifiable by one of skill in the art. FIG. 10 illustrates an example of a fusion image according to an embodiment of the invention.

In still another embodiment, additional sensors may be incorporated as part of the imaging system. For example, noise detectors may be distributed along the tracks, e.g., at a substantially similar location as the imaging device, although this location is not required. Brakes, when experiencing failure or some other issue, will often emit, in addition to an increased thermal profile, a particular noise, such as a squeal, thumping, or scratching. The noise emitted by the brakes can be captured by the noise detector and compared against the thermal image taken by the imaging device. The heat information can be correlated to the corresponding noise to provide an additional level of certainty in determining the type of failure condition that the wheel is experiencing.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

1. A system for capturing thermal images of a train passing at high speed, the system comprising:
a housing including a front portion and a rear portion;
a thermal imaging camera disposed within the housing, the camera including a lens; and
a rotating shutter disposed in the housing;
wherein:
an opening is defined in the front portion of the housing and the lens is positioned such that it has a field of view through the opening;
the rotating shutter is located between the opening and the lens;
the housing is disposed near the ground and near a railroad track; and
the field of view of the lens includes a passing rail car wheel, wherein the wheel comprises at least one bearing and brake, and wherein the camera is operable to capture at least one thermal image of the passing wheel.

2. The system of claim 1, further comprising an automatic equipment identification system, wherein the automatic equipment identification system is integrated with the thermal imaging camera such that the system provides an indication to an operator specifying a component of the wheel generating anomalous heat.

3. The system of claim 1, further comprising a calibrating system, the calibration system comprising at least one external calibration reference.

4. The system of claim 3, wherein the external calibration reference comprises a resistor heating element, wherein the resistor heating element measures temperature, and wherein the temperature is externally monitored and controlled.

5. The system of claim 4, wherein the external calibration reference comprises a rail coupled to a thermocouple.

6. The system of claim 1, wherein the camera is operable to take at least two thermal images of the passing wheel, wherein the at least two thermal images are of different perspectives of the passing wheel.

7. The system of claim 6, wherein one of the at least two thermal images is either a front perspective view or a rear perspective of the passing wheel.

8. The system of claim 1, further comprising a sensor for gathering data about the passing train, the data not being a thermal profile.

9. The system of claim 8, wherein the sensor is an audio sensor and the data is sound data from the passing wheel.

10. The system of claim 9, wherein the thermal image and the sound data are transmitted to a user.

11. The system of claim 10, further comprising an automatic equipment identification system, wherein the automatic equipment identification system is integrated with the thermal imaging camera and the sensor such that the system provides an indication to an operator specifying a component of the wheel generating anomalous heat and sound.

12. The system of claim 11, further comprising memory storing machine readable instructions that, when executed by a processor, perform the following steps:
a. receive the thermal image and the sound data from the respective camera and sensor; and
b. determine a likelihood of a failure condition.

13. The system of claim 13, wherein the failure condition is one of a sticking brake, a sliding wheel, and a non-affecting brake.

14. The system of claim 1, further comprising memory storing machine readable instructions that, when executed by a processor, perform the following steps:
a. receive the thermal image from the respective camera and sensor; and
b. determine a likelihood of a failure condition.

15. The system of claim 14, wherein the failure condition is one of a sticking brake, a sliding wheel, and a non-affecting brake.

16. The system of claim 1, wherein the thermal image profile is merged with a color image of the passing wheel to define a fusion image, wherein the color image was captured when the passing wheel is in a stationary position.

17. A system for capturing data of a wheel passing at high speed, comprising:
a housing;
a camera disposed within the housing, the camera comprising a lens; and
a rotating shutter disposed within the housing behind the lens;
wherein the housing is placed near the ground such that a field of view of the lens includes the vehicle wheel, the camera capturing a plurality of thermal images of the passing wheel.

18. The system of claim 17, wherein the thermal image comprises a pixel array, the pixel array comprising a vertical component greater than one and a horizontal component greater than one.

19. The system of claim 18, wherein the pixel array is 384×240.

20. The system of claim 17, wherein the shutter rotation is dependent on camera timing.

21. The system of claim 17, wherein the camera timing is dependent on shutter rotation.

22. A system for capturing data of a wheel passing at high speed, comprising:
a housing;
a camera disposed within the housing, the camera comprising a lens;
a rotating shutter disposed within the housing behind the lens; and
an audio sensor;
wherein:
the housing is placed near the ground such that a field of view of the lens includes the vehicle wheel, the camera capturing a plurality of thermal images of the passing wheel; and
the audio sensor is placed near the housing for determining audio data of the passing wheel.
